(19) United States
(12) Patent Application Publication
(10) Pub. No.: US 2020/0128857 A1
(43) Pub. Date: Apr. 30, 2020

(54) Beverage Component in the Form of a Micronized Fruit Pulp

(71) Applicant: TROPICANA PRODUCTS, INC., BRADENTON, FL (US)

(72) Inventors: Inna OSHMARINA, Kiev (UA); Yulia FUNTIKOVA, Moscow (RU); Aleksandr NECHAENKO, Moscow (RU); Vladimir BLIADZE, Moscow (RU)

(21) Appl. No.: 16/627,586

(22) PCT Filed: Jun. 30, 2017
(86) PCT No.: PCT/EP2017/066386

§ 371 Date: Dec. 30, 2019

(51) Int. Cl. A23L 2/02; A23L 19/00

(52) U.S. Cl. CPC A23L 2/02; A23L 2/46; A23L 19/09; A23L 19/07

(57) ABSTRACT

A beverage component in the form of a micronized fruit pulp comprised of a micronized pomace of a pomaceous fruit, wherein the fruit pulp has: a total solids content of from 4 to 10% by weight; a total dietary fibre content of from 2 to 6% by weight; and a particle size distribution wherein all the particles have a size within the range of not more than 2100 μηι; 90% of the particles have a particle size below 1700 μπι; the particles have a Volume Mean Diameter D[4,3] within the range of from 580 to 960 μπι; and the particles have a Volume Median Diameter D(v, 0.5) within the range of from 470 to 980 μπι.

### BACKGROUND OF THE INVENTION

### Field of the Invention

The present invention relates to a beverage component and to a method of manufacturing a beverage component.

### Description of the Prior Art

There is a general need in the beverage art to provide consumers with more nutritious products. In particular, in the field of fruit juices and fruit nectars, there is a need to provide the consumer with a processed fruit product which has a nutritional content as close as possible to that of the original fresh fruit. Conventional processing to produce fruit juice and fruit nectars tends to provide an end product which has lower nutritional content, for example lower fibre content, than the original fruit. The consumer perceives conventional fruit juice and fruit nectars to be less nutritious than the original fruit, and in some consumer markets this perception tends to a reduced or declining demand for fruit juice and fruit nectar products.

The present invention aims to provide a beverage component produced from a fruit which, as compared to fruit juice products that are currently commercially available, has higher nutritional content, in particular higher fibre content. When the beverage component is combined with fruit juice, and optionally fruit puree, the resultant blend can provide a fruit juice product which the consumer may perceive as having a nutritional content higher than, and closer to that of the original fruit than, conventional juice products.

### SUMMARY OF THE INVENTION

The present invention accordingly provides a beverage component in the form of a micronized fruit pulp comprised of a micronized pomace of a pomaceous fruit, wherein the fruit pulp has:
(i) a total solids content of from 4 to 10% by weight;
(ii) a total dietary fibre content of from 2 to 6% by weight; and
(iii) a particle size distribution wherein all the particles have a size within the range of not more than 2100 μm; 90% of the particles have a particle size below 1700 μm; the particles have a Volume Mean Diameter D[4,3] within the range of from 580 to 960 μm; and the particles have a Volume Median Diameter D(v, 0.5) within the range of from 470 to 980 μm

The present invention further provides a beverage comprising the beverage component according to the present invention; and at least one fruit juice, and optionally at least one fruit puree, wherein the beverage component provides in the beverage a total dietary fibre content of at least 0.6% by weight.

The beverage optionally contains only ingredients that are obtained from fruits or vegetables, and thus may be labeled as “100% fruit,” or “100% vegetable,” or “100% juice,” “100% fruit puree”, “100% fruit or vegetable fiber” depending on the local laws and regulations.

The present invention further provides a method of manufacturing a beverage component, the method comprising the steps of:
i. providing a pomace of a pomaceous fruit, wherein the pomace has a total solids content of from 15 to 40% by weight, a maximum particle size which is no greater than 5 mm, and a total dietary fibre content of from 8 to 20% by weight;
ii. mixing the pomace with at least one of water and fruit juice, or a blend thereof, to provide a pomace mixture having a total solids content of from 4 to 10% by weight, a maximum particle size which is no greater than 5 mm, and a total dietary fibre content of from 2.0 to 6.0% by weight; and
iii. reducing a particle size of the solids in the pomace mixture to provide a micronized fruit pulp comprised of micronized pomace, wherein the micronized fruit pulp has a total solids content of from 4 to 10% by weight, a total dietary fibre content of from 2.0 to 6.0% by weight, and a particle size distribution wherein all the particles have a size within the range of not more than 2100 μm; 90% of the particles have a particle size below 1700 μm; the particles have a Volume Mean Diameter D[4,3] within the range of from 580 to 960 μm; and the particles have a Volume Median Diameter D(v, 0.5) within the range of from 470 to 980 μm.

Preferred features of all of these aspects of the present invention are defined in the respective dependent claims.

In this specification, the term “pomace” means the solid remains of a pomaceous fruit after pressing of the fruit to extract the fruit juice/fruit puree therefrom; the pomace contains the pulp of the fruit, but not the seeds, stems and other non-edible parts of the fruit which have been removed from the solid remains of the fruit in an upstream separation process. The pomace is in the form of a solid pulp containing residual moisture from the fruit.

In this specification, the term “micronized” means that the particle size is reduced to provide an average particle size, D[4,3] which is the Volume Mean Diameter, which is less than 1000 μm.

In this specification, the viscosity of the micronized fruit pulp is measured using a Brookfield DV2THA No M13-167-B0614 viscometer, with spindle No. H04, at 50 rpm and at 20° C.

The preferred embodiments of the present invention can provide a novel beverage component which is produced from pomace pulp, and has a higher fibre content than conventional or current commercial fruit beverages.

The beverage component can be employed to produce fruit-based beverages which have a higher fruit content, a higher nutritional content similar to that of the original fruit, and a higher fibre content, as compared to conventional or current commercial fruit beverages.

The beverage component is sustainably sourced from pomace, for example apple and/or pear pomace.

The beverage component can be produced from pomace generated as a by-product in a fruit puree or fruit juice processing line. The beverage component can then be combined with the fruit juice, and optionally additionally the fruit puree, to provide a fruit beverage that has a nutritional content, and fibre content, closer to the original fruit as compared to fruit juice products that are currently commercially available.

This invention effectively uses an ingredient, pomace pulp, which in many conventional fruit processing lines for the production of fruit juice or fruit puree, is treated as a waste product which is not incorporated into a fruit-based foodstuff or beverage. In the present invention, the pomace pulp is recovered and processed to form a high fibre beverage component which has a selected range of total solids and fibre content, to be readily incorporated into a fruit beverage by combining with at least one fruit juice, and optionally at least one fruit puree.

Currently, pomace is mostly used commercially as a fodder for animals or as a fertilizer, or as a source of bioactive compounds, such as polyphenols, to be extracted therefrom.

The present invention provides a sustainable and higher value use for pomace which can be incorporated into a beverage component to provide a beverage component with higher fruit content and higher dietary fibre content than known juice products.

The preferred embodiments of the present invention employ pomace as a raw ingredient for manufacturing the beverage component.

The beverages produced in accordance with the present invention are preferably provided in a consumer acceptable retail format, for example a packaging such as a bottle or carton, typically hermetically sealed, and typically aseptically packaged, which is compatible with a retail sales environment.

In this specification, the total dietary fibre (TDF) is measured using the protocol defined by AOAC International, Rockville, Md., USA, in Official Test Method AOAC 991.43.

In this specification, the total solids (TS) content is measured using the protocol set out by the International Fruit and Vegetable Juice Association (IFU), Paris France, as defined in IFU Method #61 for the “Determination of total dry matter”, which is also defined in DIN EN 12145 (1996-10).

In this specification, the particle size and particle size distribution are measured using a Malvern Mastersizer 2000 analytical instrument.

### BRIEF DESCRIPTION OF THE DRAWINGS

Embodiments of the present invention will now be described by way of example only with reference to the accompanying drawings, in which:

### DETAILED DESCRIPTION OF THE EMBODIMENTS OF THE INVENTION

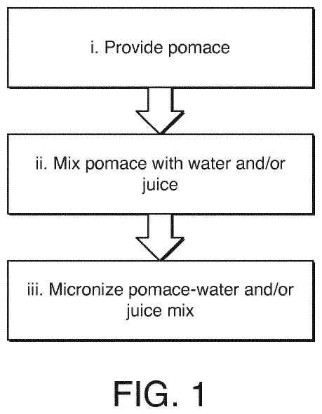

FIG. 1 schematically illustrates a process flow of a method for manufacturing a beverage component in accordance with an embodiment of the present invention; and

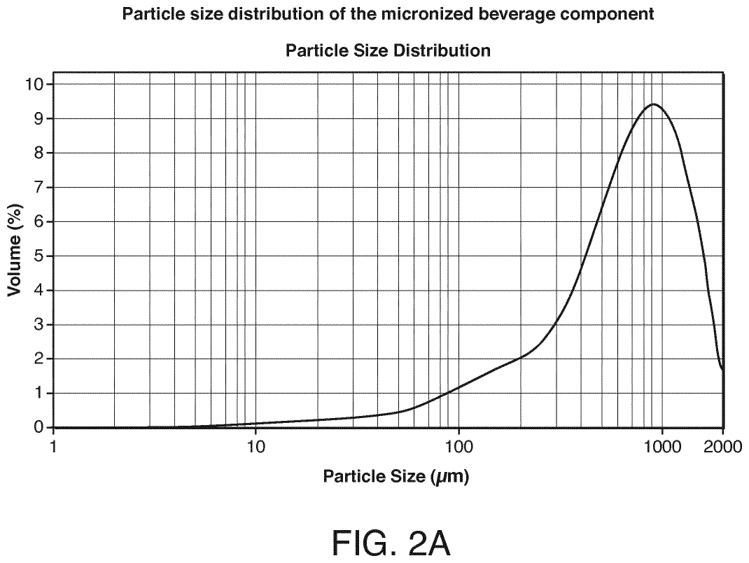

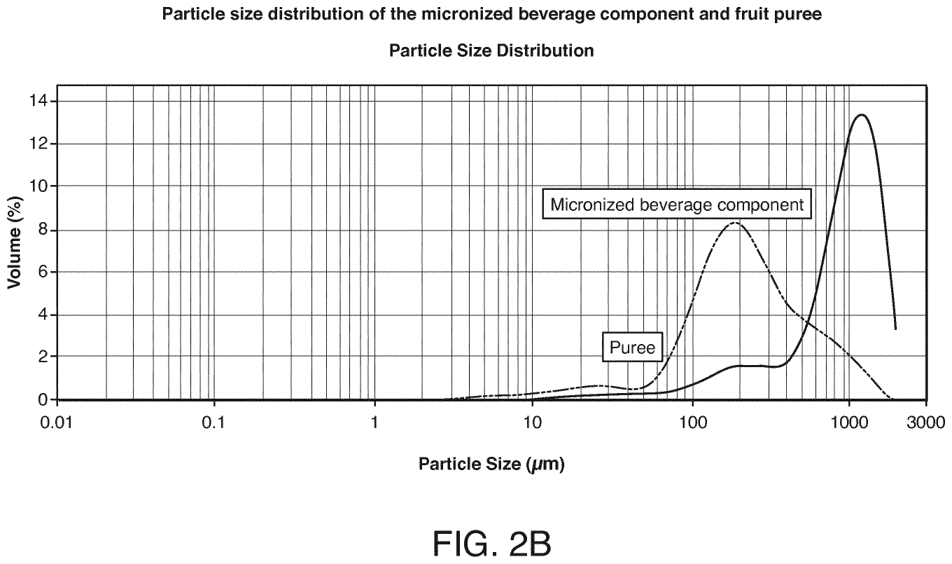

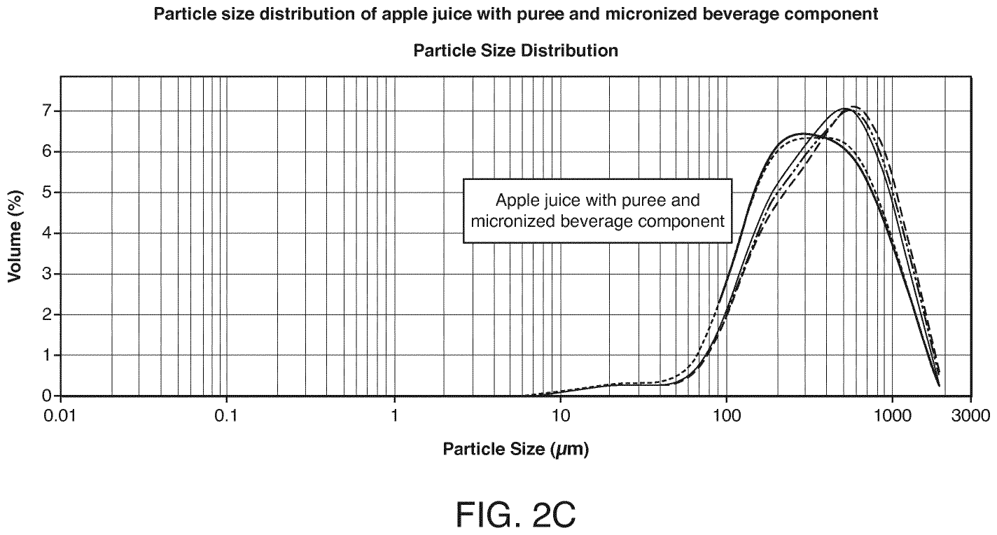

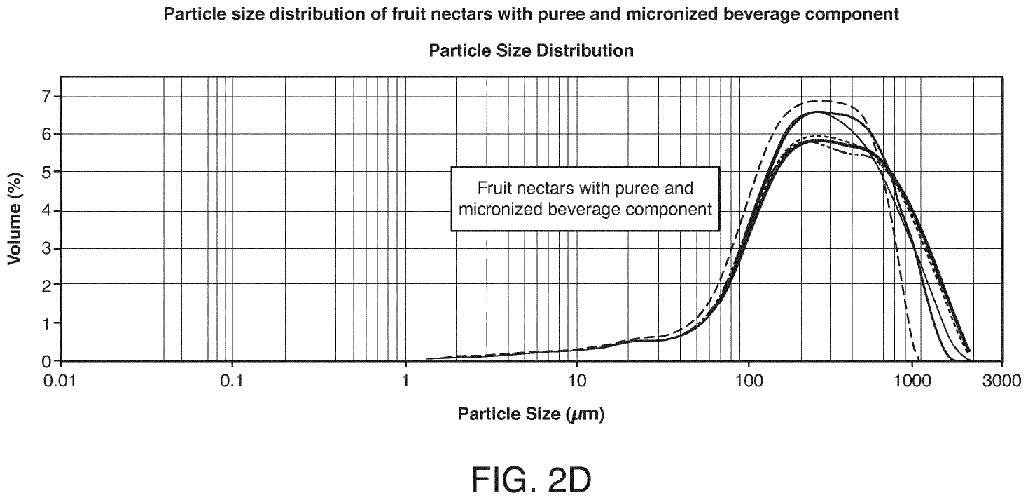

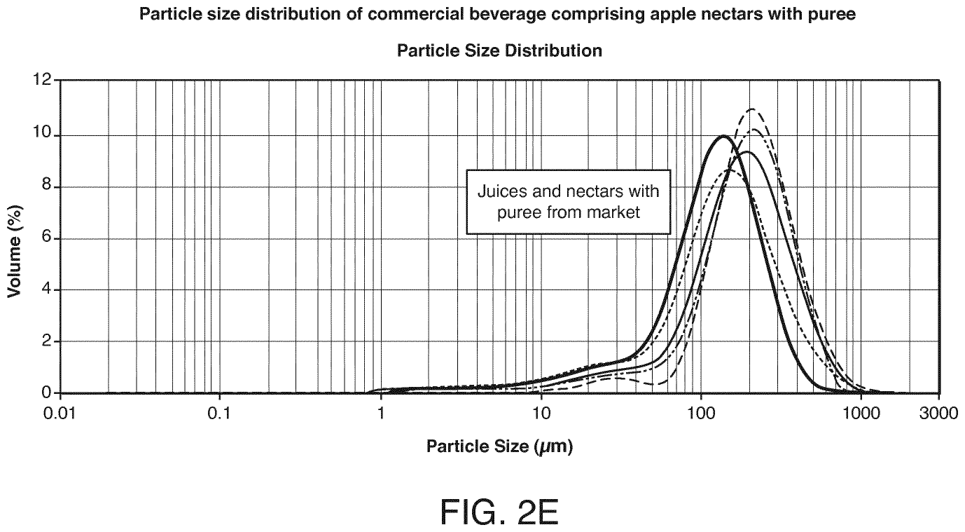

FIGS. 2a to 2e illustrate the particle size distribution, with respect to volume, of, respectively, (a) a beverage component in accordance with an embodiment of the present invention, (b) a fruit puree in comparison, (c) a first beverage in accordance with an embodiment of the present invention, (d) a second beverage in accordance with an embodiment of the present invention, and (e) a commercial fruit beverage.

Referring to FIG. 1 of the accompanying drawings, an embodiment of a method of manufacturing a beverage component is schematically illustrated.

In step i, a pomace of a pomaceous fruit is provided. Typically, the pomaceous fruit is apple, although any other pomaceous fruit such as pear may be employed, either alone or in combination with any other pomaceous fruit or fruits.

As described above, the pomace is the solid remains of a pomaceous fruit after pressing of the fruit to extract the fruit juice therefrom; the “pomace” contains the pulp of the fruit, but not the seeds, stems and other non-edible parts of the fruit which have been removed from the solid remains of the fruit in an upstream sieving operation. The pomace is in the form of a solid pulp containing residual moisture from the fruit.

In one embodiment of the present invention, the pomace may be the byproduct of a fruit puree processing line. In such a line, fresh fruit, such as apples, are crushed and then subjected to a first refining process in which waste solids are sieved off. The waste solids comprise seeds, stems and other non-edible parts of the fruit. The sieve typically has a sieve opening size of 1.5-4.0 mm. The sieved waste solids are recovered and the filtrate, or puree feedstock, is subsequently processed to produce the beverage component of the present invention and a fruit puree.

Thereafter, the resultant first-refined feedstock is subjected to enzymatic deactivation, for example by heating to a temperature of from 65 to 95° C. Alternatively, the enzymatic deactivation step may be carried out before the first refining process.

The puree feedstock is then subjected to a second refining process in which the raw pomace, comprising pulp solids, is sieved off from the puree feedstock. The pulp solids typically comprise from 1 to 10% by weight of the apple feedstock. The sieve typically has a sieve opening size of 0.4-0.8 mm.

In accordance with this invention, the pulp solids sieved off in the second refining process are further processed to produce a beverage component having higher dietary fibre than known juice products.

The filtrate from the second refining process, comprising the puree feedstock, is then pasteurized, and then the puree is aseptically packaged or stored for subsequent use or processing.

The resultant sieved-off pomace is in the form of a solid pulp containing residual moisture from the fruit. The pomace typically has a total solids content of from 20 to 40% by weight, for example a total solids content of from 22 to 28% by weight. The pomace also has a total dietary fibre content of from 8 to 20% by weight, for example from 12 to 16% by weight. The pomace also has a maximum particle size which is no greater than 5 mm, for example a maximum particle size which is no greater than 3-5 mm, for example which is no greater than 4 mm. The pomace, when apple pomace, has a pH of typically less than 4.2, more typically less than 3.9.

For colour correction one or more antioxidants, for example ascorbic acid, can be added to the pomace.

Typically, the pomace from the second refining process has a temperature of from 65 to 85° C., for example from 65 to 70° C. The pomace is the raw by-product from a fruit puree processing line, and typically comprises from 1 to 10% by weight of the fresh fruit, for example apple, fed into the fruit puree processing line.

Thereafter, in step ii the pomace, at a temperature of from 65 to 85° C., is mixed with at least one of water and fruit juice, or a blend thereof, to provide a uniform pomace mixture. The pomace may be used directly from the puree processing line. However, the pomace may have been previously collected and stored in a frozen/chilled condition, and subsequently defrosted or otherwise prepared for mixing with water. The pomace may be mixed with water or 100% fruit juice or any blend of water and fruit juice. Typically, the water is at a temperature of from 10 to 25° C. After mixing the pomace with water in step ii, the pomace mixture has a temperature of from 30 to 50° C. The pomace and at least one of water and fruit juice, or a blend thereof, are mixed in a weight ratio of from 1:2 to 1:5, for example 1:3 to 1:4.5. The pomace and at least one of water and fruit juice, or a blend thereof, are mixed. The mixing may be carried out in any suitable mixing apparatus to achieve a desired particle distribution, for example a dynamic mixer.

The pomace mixture produced in step ii has a total solids content of from 4 to 10% by weight for example from 4.5 to 6.5% by weight. The pomace mixture produced in step ii has the same maximum particle size which is no greater than 5 mm, for example which is no greater than 3-5 mm, for example 4 mm, as the initial pomace. The pomace mixture produced in step ii has a total dietary fibre content of from 2 to 6% by weight, for example from 2.3 to 3.2% by weight.

In another embodiment of the present invention, the pomace may be the byproduct of a fruit juice processing line. In such a line, fresh fruit, such as apples, are subjected to a typical juice separation process, for example using a belt press, bucher press, decanter etc.

In accordance with this invention the resultant apple product is subjected to a first refining process in which waste solids are sieved off. The waste solids comprise the seeds, stems and other non-edible parts of the fruit. The sieve typically has a sieve opening size of 1.5-4.0 mm. The sieved waste solids are recovered and the filtrate, or juice feedstock, is subsequently processed to produce the beverage component of the present invention and a fruit juice.

Thereafter, the resultant first-refined feedstock is subjected to enzymatic deactivation, for example by heating to a temperature of from 65 to 80° C.

Alternatively, the enzymatic deactivation step may be carried out before the first refining process.

The juice feedstock is then subjected to a second refining process in which the raw pomace, comprising pulp solids, is separated from the juice feedstock. The pulp solids typically comprise from 10 to 30% by weight of the apple feedstock. The filtrate is processed to produce a fruit juice.

The resultant pomace is in the form of a solid pulp containing residual moisture from the fruit. The pomace typically has a total solids content of from 15 to 40%, for example a total solids content of from 18 to 28% by weight. The pomace also has a total dietary fibre content of from 8 to 20% by weight, for example from 8 to 14% by weight. The pomace also has a maximum particle size which is no greater than 5 mm, for example a maximum particle size which is no greater than 3-5 mm, for example 4 mm. The pomace, when apple pomace, has a pH of typically less than 4.2, more typically less than 3.9. Typically, the pomace from the second refining process has a temperature of from 65 to 85° C., for example from 65 to 70° C. The pomace is the raw by-product from a fruit juice processing line, and typically comprises from 10-30% by weight of the fresh fruit, for example apple, fed into the fruit juice processing line. As described above for the puree embodiment, one or more antioxidants may be added to the pomace.

Thereafter, as also described above for the puree embodiment, in step ii the pomace, at a temperature of from 65 to 85° C., is mixed with at least one of water and fruit juice, or a blend thereof, to provide a pomace mixture which has a total solids content of from 4 to 10% by weight for example from 4.5 to 6.5% by weight. The pomace mixture produced in step ii has the same maximum particle size which is no greater than 5 mm, for example which is no greater than 3-5 mm, for example 4 mm, as the initial pomace. The pomace mixture produced in step ii has a total dietary fibre content of from 2 to 6% by weight, for example from 2.3 to 3.2% by weight.

In each embodiment, in either a puree or juice processing line, the pomace mixture comprises a feedstock for subsequent processing to form a beverage component in accordance with the present invention.

Thereafter, in step iii, the pomace mixture is subjected to a particle size reduction step to provide a micronized fruit pulp comprised of micronized pomace. The particle size reduction step may be carried out in an apparatus such as a colloid mill, a micronizing machine/disperser, a rotary propulsion apparatus, a single stage and multi-stage rotor/stator pair, a disintegrator, a slot (mesh) disperser, a high-pressure plunger homogenizer, or any other apparatus known in the art to be suitable to micronize a mixture having or similar to the composition and properties described above for the pomace mixture to provide a micronized fruit pulp. The micronized fruit pulp has the same total solids content and total dietary fibre content as the pomace mixture produced in step ii. In other words, the total solids content is from 4 to 10%, for example from 4.5 to 6.5% by weight, and the total dietary fibre content of from 2 to 6%, for example from 2.3 to 3.2% by weight.

Typically, the micronized fruit pulp has a viscosity within the range of from 1000-9000 cP.

The micronized fruit pulp has a smaller particle size than the pomace mixture as a result of the particle size reducing step. The micronized fruit pulp has a particle size distribution in which the particles have a Volume Mean Diameter D[4,3] within the range of from 580 to 960 μM. In the particle size distribution, all the particles have a size within the range of not more than 2100 μm. In addition, 90% of the particles have a particle size below 1700 μm. The particles have a Volume Median Diameter D(v, 0.5) within the range of from 470 to 980 μm. Preferably, in the particle size distribution 10% of the particles have a particle size below 300 μm.

After the particle size reducing step iii, in step iv the micronized fruit pulp is sterilized at an elevated temperature. The sterilized micronized fruit pulp comprises a beverage component with higher dietary fibre content than known juice products. The micronized fruit pulp comprises or consists of the micronized pomace and water and/or fruit juice.

The beverage component is subsequently used to manufacture a beverage.

In one embodiment, the beverage component is mixed with at least one fruit juice to provide a beverage. The mixing ratio may be selected so that the beverage component provides in the beverage a total dietary fibre content of at least 0.6% by weight. Additionally, the mixing ratio may be selected such that the beverage has a particle size distribution wherein 90% of the particles have a particle size below 1100 μm; and all of the particles have a particle size below 1900 μm. In a preferred embodiment, there is provided a beverage comprising from 10 to 50 vol % of the beverage component and from 50 to 90 vol % of at least one fruit juice, each vol % value being based on the total weight of the beverage component and the at least one fruit juice. Typically, the beverage component and the at least one fruit juice comprise from 95 to 100 vol %, most typically 100 vol %, of the beverage. Typically, the fruit juice is composed of the same fruit as the micronized pomace, for example apple.

The beverage optionally contains only ingredients that are obtained from fruits or vegetables, and thus may be labeled as “100% fruit,” or “100% vegetable,” or “100% juice,” “100% fruit puree”, “100% fruit or vegetable fiber” depending on the local laws and regulations.

In one example, the beverage comprises from 10 to 40% by volume of the pomace-derived beverage component and from 60 to 90% by volume of fruit juice.

In another preferred embodiment, there is provided a beverage comprising from 1 to 50 vol % of the beverage component; from 10 to 90 vol % of at least one fruit juice; and from 1 to 30 vol % of at least one fruit puree, each vol % value being based on the total weight of the beverage component, the at least one fruit juice and the at least one fruit puree. Typically, the beverage component, the at least one fruit juice and the at least one fruit puree comprise from 95 to 100 vol %, most typically 100 vol %, of the beverage.

In one example, the beverage comprises from 10 to 40% by volume of the pomace-derived beverage component, from 50 to 80% by volume of fruit juice and from 10 to 40% by volume of fruit puree.

Typically, the fruit puree is composed of the same fruit as the micronized pomace, and/or the fruit juice is composed of the same fruit as the micronized pomace, for example apple. The fruit puree may have a particle size distribution wherein at least 90% of the particles have a particle size below 1200 The fruit puree may have a particle size distribution wherein a Volume Mean Diameter D[4,3] is within the range of from 300 to 570 μm.

Preferably, the beverage has a particle size distribution wherein all the particles have a size below 1900 μml; 90% of the particles have a particle size below 1100 μm; the particles have a Volume Mean Diameter D[4,3] within the range of from 270 to 530 μm; and the particles have a Volume Median Diameter D(v, 0.5) within the range of from 225 to 430 μm. furthermore, preferably, the beverage has a particle size distribution wherein 10% of the particles have a particle size below 130 μm.

Other components may be added to the beverage, such as water in a sufficiently small concentration to maintain the desired high fibre and nutritional content to be considered as a whole fruit and highly nutritional beverage product similar to the original fruit, sweetener such as sugar and acidifier such as citric acid. It will be apparent to those skilled in the art that other components such as nutritional additives, for example vitamins, flavourings, for example fruit pieces, juice, puree or extracts, colorants, flavours etc. may be added to the beverage. However, since a primary objective is to provide a natural juice product that may be described as providing the nutritional qualities of whole fruit, any added components are typically natural additives, rather than artificial additives.

The present invention will now be described further with reference to the following non-limiting Example.

### Example 1

This example produced an apple pomace product in a puree processing line.

An apple pomace in the form of a solid pulp was processed according to the invention as described above in a puree processing line. Crushed apples were subjected to an initial sieving step to remove inedible seeds, stalks, and other non-edible parts of the fruit, and then the apples were subjected to a second sieving step to produce a pomace in the form of fruit pulp, which was subsequently processed as described below to produce a beverage component, and a puree feedstock which was used to produce an apple puree product.

The apple pomace had a total solids content 24% by weight, a total dietary fibre content of 12.5% by weight and a maximum particle size which is no greater than 5 mm. The pomace, at a temperature of 80° C., was mixed with water, at a temperature of from 15° C., in a weight ratio of from 1:3.5 to 1:4 in a mixer to ensure a uniform particle size distribution. The pomace-water mixture had a temperature of 43° C. The pomace-water mixture had a total solids content of 5.5% by weight, the same maximum particle size which is no greater than 5 mm as the initial pomace, and a total dietary fibre content of about 2.5% by weight.

The pomace-water mixture was subjected to a particle size reduction step as described above to provide a micronized fruit pulp comprised of micronized pomace. The micronized fruit pulp has the same total solids content and total dietary fibre content as the pomace-water mixture. The micronized fruit pulp had a smaller particle size than the pomace-water mixture as a result of the particle size reduction step.

The particle size distribution of the micronized fruit pulp was measured and the resultant distribution is shown in FIG. 2a, which shows the relationship between volume % and particle size in μm. It may be seen that the distribution formed a relatively narrow distribution, with a peak, a relatively gradual climb at lower particle sizes than the peak and a relatively sharp drop at higher particle sizes than the peak.

The micronized fruit pulp had a particle size distribution wherein all the particles have a size within the range of not more than 2100 μm; 90% of the particles have a particle size below 1700 μm; the particles have a Volume Mean Diameter D[4,3] within the range of from 580 to 960 μm; and the particles have a Volume Median Diameter D(v, 0.5) within the range of from 470 to 980 μm.

The particle size distribution of the micronized fruit pulp produced in Example 1 is shown in Table 1. In Table 1, the particle size parameter D(v, 0.9) defines the proportion, expressed as a percentage in this specification, by volume of the particles in the respective size range.

TABLE 1

| | D(v, 0.5) | D(v, 0.9) | D [4,3] | D(max) |
|---|---|---|---|---|
| | μm | μm | μm | μm |
| Example 1 - beverage | 470-980 | 1230-1700 | 580-960 | 2100 |
| component (FIG. 2a) | | | | |
| Comparative Example 1 - | 230-500 | 600-1200 | 300-570 | 1780 |
| puree (FIG. 2b) | | | | |
| Examples 3 and 4 - beverage | 225-430 | 560-1100 | 270-530 | 1900 |
| product with the micronized | | | | |
| fruit pulp and juice/nectars | | | | |
| (FIGS. 2c and 2d) | | | | |
| Comparative Example 3 - | 125-210 | 260-440 | 140-250 | 800 |
| commercial beverage (FIG. | | | | |
| 2e) | | | | |

The micronized fruit pulp was sterilized by heating.

The micronized fruit pulp can be differentiated from a fruit puree having the particle size distribution shown in FIG. 2b and as shown as Comparative Example 1 in Table 1.

It may be seen that in the puree, the particle size distribution of the puree formed a slightly broader distribution, wherein all the particles have a size within the range of not more than 1780 μm; 90% of the particles have a particle size below 1200 μm; the particles have a Volume Mean Diameter D[4,3] within the range of from 300 to 570 μm; and the particles have a Volume Median Diameter D(v, 0.5) within the range of from 230 to 500 μm.

When the mixture of the micronized fruit pulp and the puree was tested, the resultant particle size distribution of the blend of the beverage component and the puree as shown in FIG. 2b was produced. It may be seen that the distribution of the mixture of the micronized fruit pulp and the puree is broadened by combining the two individual distributions.

When combined with added fruit juice to provide a beverage product which has acceptable viscosity and pouring characteristics to replace a conventional fruit juice product, the new beverage had a total dietary fibre content of at least 0.6% by weight and at least 90% of the particles have a particle size below 1100 μm. This particle size distribution was found in consumer testing to provide an attractive sensation which gave the impression that a nutritious whole fruit product was being consumed. When the beverage component was combined with fruit juice, the resultant blend was found to provide a fruit juice product which the consumer may perceive as having a nutritional content higher than, and closer to that of the original fruit than, conventional juice products. Also consumers noticed that new beverage has real home-made juice profile, taste of fresh apples, nourishing, healthy product; number of triers claimed they especially liked the texture.

In particular, in the consumer test the testers gave an above average score to the following criteria concerning the beverage product: high quality product; good source of vitamins/nutrients; good balance of taste and health; taste close to the real fruit itself; healthy product; and made with natural ingredients. These results show that the product is perceived by consumers as natural and healthy.

### Example 2

This example produced an apple pomace product in a juice processing line.

An apple pomace in the form of a solid pulp was processed according to the invention as described above in a juice processing line. Crushed apples were subjected to an initial sieving step to remove inedible seeds, stalks, and other non-edible parts of the fruit, and then the apples were subjected to a second sieving step to produce a pomace in the form of fruit pulp, which was subsequently processed as described below to produce a beverage component, and a juice feedstock which was used to produce an apple juice product.

The pomace had a total solids content 20% by weight, a total dietary fibre content of 10% by weight and a maximum particle size which is no greater than 5 mm. The pomace, at a temperature of 65° C., was mixed with water, at a temperature of from 15° C., in a weight ratio of from 1:3 in a mixer to ensure a uniform particle size distribution. The pomace-water mixture had a temperature of 38° C.

The pomace-water mixture had a total solids content of from 5.5% by weight, the same maximum particle size which is no greater than 5 mm as the initial pomace, and a total dietary fibre content of about 2.3% by weight.

The pomace-water mixture was subjected to a particle size reduction step to form a beverage component as described above for Example 1. The beverage component had the same particle size distribution as for Example 1.

### Example 3

A juice beverage was prepared having the ingredients listed in Table 2 below. Such a beverage had a particle size distribution wherein 90% of the particles have a particle size below 1100 μm; and all of the particles are within the particle size of below 1900 μm. The particles have a Volume Mean Diameter D[4,3] within the range of from 270 to 530 μm; and the particles have a Volume Median Diameter D(v, 0.5) within the range of from 225 to 430 μm.

TABLE 2

| | Amount (weight % of |
|---|---|
| | total beverage) |
| Apple juice (restored from concentrate) | 70% |
| Apple puree | 10% |
| Apple pomace component | 20% |

In contrast, a conventional drinkable fruit juice-based product containing fruit puree has a particle size distribution wherein 90% of the particles have a particle size below 440 μm; and all of the particles are within the particle size below 800 μm.

The higher particle size of the particle size distribution of the beverage of Example 3 as compared to the conventional beverage provides a sensory experience which provides the impression of a whole fruit product. In addition, the pomace ingredient provides enhanced dietary fibre content to the beverage of Example 3.

The particle size distribution of the beverage comprising apple juice, apple puree and the beverage component produced in Example 1 is shown in FIG. 2c and Table 1.

### Example 4

The beverage component produced in Example 1 was blended with a mixture of fruit juices and a mixture of purees in a combination listed in Table 3 to obtain a beverage in the form of a fruit nectar.

TABLE 3

| | Amount (weight % of |
|---|---|
| | total beverage) |
| Fruit/berry juice (restored from concentrate) | 15-35% |
| Fruit/berry puree | 10-30% |
| Apple pomace component | 20-25% |

The resultant particle size distribution is shown in Table 1 and FIG. 2d. Such a beverage had a particle size distribution wherein 90% of the particles have a particle size below 1100 μm; and all of the particles are below 1900 μm. The particles have a Volume Mean Diameter D[4,3] within the range of from 270 to 530 μm; and the particles have a Volume Median Diameter D(v, 0.5) within the range of from 225 to 430 μm.

This particle size distribution was found in consumer testing to provide an attractive sensation which gave the impression that a nutritious whole fruit product was being consumed.

In contrast, a conventional drinkable fruit juice-based product containing fruit puree has a particle size distribution wherein 90% of the particles have a particle size below 440 μm; and all of the particles are below 800 μm.

The particle size distribution of the nectars with micronized fruit pulp produced in Example 1 is shown in FIG. 2d and Table 1.

### Comparative Example 3

A commercial fruit beverage comprising a fruit juice/fruit puree blend (prepared as a fruit juice or fruit nectar) was tested to determine the particle size distribution, which is also shown in Table 1. It can be seen from Table 1 that the commercial fruit beverage has a Volume Mean Diameter D[4,3] within the range of from 140 to 250 μm, a Volume Median Diameter D(v, 0.5) within the range of from 125 to 210 μm, and a D(v, 0.9) within the range of from 260 to 440 μm, with a maximum particle size of 800 μm.

This particle size distribution was found in consumer testing not to provide the impression that a nutritious whole fruit product was being consumed.

It can be seen from Table 1 that by providing the pomace-derived beverage component in the beverage of Example 1, the particle size distribution in the resultant beverages of Examples 3 and 4 has a Volume Mean Diameter D[4,3] within the range of from 270 to 530 μm, a Volume Median Diameter D(v, 0.5) within the range of from 225 to 430 μm, and a D(v, 0.9) within the range of from 560 to 1100 μm.

All of these particle size ranges are higher than the respective ranges for the commercial fruit beverage product of Comparative Example 3, even though both compositions are fruit juice and fruit nectar, and the beverage product of Comparative Example 3 comprises only fruit juice and fruit puree.

The particle size distribution of Examples 3 and 4 provides an improved sensory experience compared to the commercial fruit beverage product of Comparative Example 3. When the beverage component of Example 1 was combined with fruit juice and puree, the resultant blend of Examples 3 and 4 was found to provide a fruit juice product which the consumer perceived as having a nutritional content higher than, and closer to that of the original fruit than, conventional juice products including juice, and puree/pulp.

Additionally, a higher dietary fibre product was also provided by providing the pomace-derived beverage component of Example 1 in the beverage of Examples 3 and 4.

The resultant particle size distribution in Comparative Example 3 is shown in Table 1 and FIG. 2e.

### Examples 5 and 6

Beverage components formed from pear pomace were prepared using the process steps described above for Examples 1 and 2. The beverage components had a particle size distribution falling within the scope of the present invention.

Various other modifications to the present invention will be readily apparent to those skilled in the art.

1. A beverage component in the form of a micronized fruit pulp comprised of a micronized pomace of a pomaceous fruit, wherein the fruit pulp has:
(i) a total solids content of from 4 to 10% by weight;
(ii) a total dietary fiber content of from 2 to 6% by weight; and
(iii) a particle size distribution wherein all the particles have a size within the range of not more than 2100 μm; 90% of the particles have a particle size below 1700 μm; the particles have a Volume Mean Diameter D[4,3] within the range of from 580 to 960 μm; and the particles have a Volume Median Diameter D(v, 0.5) within the range of from 470 to 980 μm.

2. The beverage component according to claim 1 wherein the pomaceous fruit is apple.

3. (canceled)

4. (canceled)

5. (canceled)

6. The beverage component according to claim 1 wherein the micronized fruit pulp has a particle size distribution wherein 10% of the particles have a particle size below 300 μm.

7. The beverage component according to claim 1 wherein the micronized fruit pulp has a viscosity within the range of from 1000-9000 cP.

8. The beverage component according to claim 1 wherein the micronized fruit pulp comprises the micronized pomace, and at least one of water and fruit juice, or a blend thereof.

9. (canceled)

10. The beverage component according to claim 8 wherein in the micronized fruit pulp the micronized pomace, and at least one of water and fruit juice, or a blend thereof, are in a ratio of from 1:3 to 1:4.5 by weight.

11. (canceled)

12. (canceled)

13. (canceled)

14. A beverage comprising:
i. from 10 to 50 vol % of the beverage component of claim 1; and
ii. from 50 to 90 vol % of at least one fruit juice,
each vol % value being based on the total weight of the beverage component and the at least one fruit juice.

15. (canceled)

16. A beverage comprising:
i. from 1 to 50 vol % of the beverage component of claim 1;
ii. from 10 to 90 vol % of at least one fruit juice; and
iii. from 1 to 30 vol % of at least one fruit puree,
each vol % value being based on the total weight of the beverage component, the at least one fruit juice and the at least one fruit puree.

17. (canceled)

18. The beverage according to claim 16 wherein the fruit puree is composed of the same fruit as the micronized pomace.

19. The beverage according to claim 14 wherein the fruit juice is composed of the same fruit as the micronized pomace.

20. A method of manufacturing a beverage component, the method comprising the steps of:
i. providing a pomace of a pomaceous fruit, wherein the pomace has a total solids content of from 15 to 40% by weight, a maximum particle size which is no greater than 5 mm, and a total dietary fiber content of from 8 to 20% by weight;
ii. mixing the pomace with at least one of water and fruit juice, or a blend thereof, to provide a pomace mixture having a total solids content of from 4 to 10% by weight, a maximum particle size which is no greater than 5 mm, and a total dietary fiber content of from 2.0 to 6.0% by weight; and
iii. reducing a particle size of the solids in the pomace mixture to provide a micronized fruit pulp comprised of micronized pomace, wherein the micronized fruit pulp has a total solids content of from 4 to 10% by weight, a total dietary fiber content of from 2.0 to 6.0% by weight, and a particle size distribution wherein all the particles have a size within the range of not more than 2100 μm; 90% of the particles have a particle size below 1700 μm; the particles have a Volume Mean Diameter D[4,3] within the range of from 580 to 960 μm; and the particles have a Volume Median Diameter D(v, 0.5) within the range of from 470 to 980 μm.

21. The method according to claim 20 wherein the pomaceous fruit is an apple.

22. (canceled)

23. (canceled)

24. (canceled)

25. The method according claim 20 wherein the micronized fruit pulp in step iii has a particle size distribution wherein 10% of the particles have a particle size below 300 μm.

26. The method according to claim 20 wherein the micronized fruit pulp in step iii has a viscosity within the range of from 1000-9000 cP.

27. (canceled)

28. The method according to claim 20 wherein in step i the pomace has a total solids content of from 18 to 28%.

29. The method according to claim 20 wherein in step i the pomace has a total dietary fiber content of from 8 to 16%.

30. The method according to claim 20 wherein the pomace in step i and the pomace mixture in step ii have a maximum particle size which is no greater than 4 mm.

31. The method according to claim 20 wherein in step ii the pomace has a temperature of from 65 to 85° C., and after mixing with at least one of water and fruit juice, or a blend thereof, the pomace mixture has a temperature of from 30 to 50° C.

32. The method according to claim 20 wherein in step ii the pomace and at least one of water and fruit juice, or a blend thereof, are in a ratio of from 1:3 to 1:4.5 by weight.

33. (canceled)

34. The method according to claim 20 wherein in step ii the pomace is mixed with 100% fruit juice.

35. (canceled)

36. (canceled)

37. (canceled)

38. (canceled)
